(19) United States
(12) Patent Application Publication
(10) Pub. No.: US 2005/0224997 A1
(43) Pub. Date: Oct. 13, 2005

(54) Method of fabricating optical substrate

(76) Inventors: Tsung-Neng Liao, Taichung County (TW); Francis Chung Hwa Pan, Taichung Hsien (TW); John Chungteh Pan, Taichung City (TW); Chun-Chi Lee, Taipei City (TW)

Correspondence Address: BIRCH STEWART KOLASCH & BIRCH, PO BOX 747, FALLS CHURCH, VA, 22040-0747, US

(21) Appl. No.: 10/819,931

(22) Filed: Apr. 8, 2004

(51) Int. Cl. B29D 11/00

(52) U.S. Cl. 264/1.7; 264/2.7

(57) ABSTRACT

A method of fabricating an optical substrate has the steps of: Heat a first material and a second material to their melt conditions. Stack the first material and the second material. Roll a stack of the first material and the second material and mold a surface profile on the second material by means of a roller calender with a figured texture to mold a substrate with a surface thereon. Cool the substrate and cut the substrate.

### BACKGROUND OF THE INVENTION

1. Field of the Invention

The present invention relates generally to an optical device, and more particularly to a method of fabricating an optical substrate.

2. Description of the Related Art

A conventional direct-light backlight module has a frame on which a reflector film, lamps and a diffuser plate are mounted in sequence. The lamps emit light to both of the diffuser plate and the reflector film and the reflector film reflects the light to the diffuser film. The diffuser plate diffuses the light and provides it to a liquid crystal panel.

The conventional diffuser plate has a substrate on which a diffusive film, a prism film and a brightness enhancement film are laminated in sequence. These films are very expensive. In the old method, the processes of lamination of the films are done by handwork. The cost of fabrication of the diffuser plate is higher.

In the processes of laminating the films on the substrate, tape has to be laminated on the substrate or the films respectively. The optical characters of the diffuser plate depends on, except for the inherent optical characters of the films, whether the glue is coated in a uniform condition or not and whether the films are laminated in a uniform condition or not. The human error in the processes of lamination makes the conventional diffuser plates having a greater proportion defective.

### SUMMARY OF THE INVENTION

The primary objective of the present invention is to provide a method of fabricating an optical substrate, which the process is easier and has a less proportion of defective.

According to the objective of the present invention, a method of fabricating an optical substrate comprises the steps of:
(A) Heat a first material and a second material to their melt conditions.
(B) Stack the first material and the second material.
(C) Press a stack of the first material and the second material to mold a substrate with a predetermined width and a predetermined thickness;
(D) Mold a surface profile on the substrate, and
(E) Cool the substrate.

### BRIEF DESCRIPTION OF THE DRAWINGS

FIG. 1 is a flow chart of a first preferred embodiment of the present invention;

FIG. 2 is a sectional view of the first optical substrate made by the method of the first preferred embodiment of the present invention;

FIG. 3 is a sectional view of the second optical substrate made by the method of the first preferred embodiment of the present invention;

FIG. 4 is a sectional view of the third optical substrate made by the method of the first preferred embodiment of the present invention;

FIG. 5 is a flow chart of a second preferred embodiment of the present invention;

FIG. 6 is a sectional view of the first optical substrate made by the method of the second preferred embodiment of the present invention, and

FIG. 7 is a sectional view of the second optical substrate made by the method of the second preferred embodiment of the present invention.

### DETAILED DESCRIPTION OF THE INVENTION

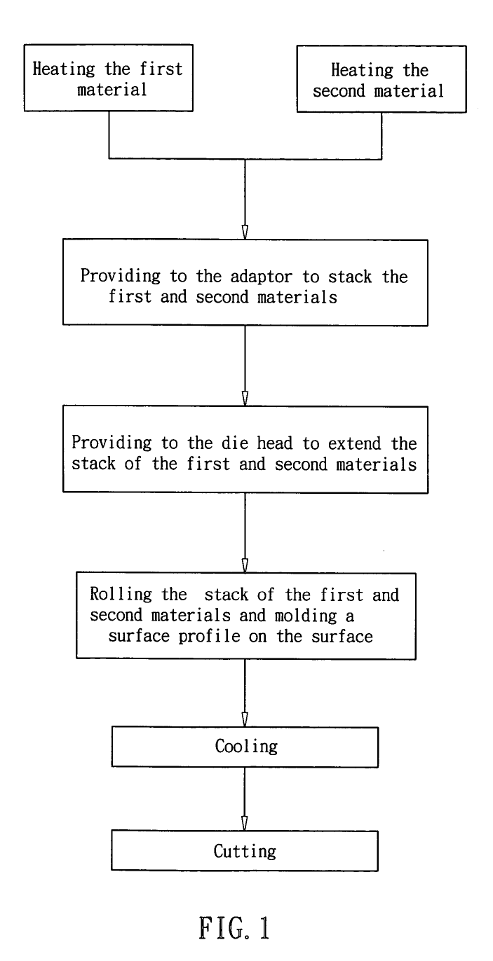

As shown in FIG. 1, a method of fabricating an optical substrate of the first preferred embodiment of the present invention comprises the steps of:

(A) Heat a first material and a second material to melt conditions:

The first material and the second material are plastic grains before heating. The first material and the second material are chosen from Polymethyl methacrylate, (PMMA), Polycarbonate (PC) or Cyclic Olefins Polymer (COP) etc.

(B) Provide the melted first material and the melted second material to an adapter. In the adaptor, the second material is stacked on the first material. The adaptor designates the ratio of thickness of the first material and the second material.

(C) Provide a stack of the first material and the second material to a die head. In the die head, the stack of the first material and the second material are extended to a predetermined width.

(D) Roll the stack of the first material and the second material by a set of roller calenders to mold a substrate with a predetermined thickness. One of the roller calenders has a figured texture on an annular surface thereof to mold a predetermined surface profile on the second material while the stack is rolled.

(E) Cool the substrate for solidification, and

(F) Cut the substrate into a plurality of optical substrates.

According to the steps of the method of the present invention, the optical substrates are made in a series of processes without any handwork involved. The proportion of defective is reduced. The optical substrate has a thickness greater than 0.5 mm, more preferable the thickness of the optical substrate is in a range of between 1 mm and 5 mm. The second material of the optical substrate has a thickness greater than 1 μm, more preferable the thickness of the second material in a range of between 50 μm and 200 μm.

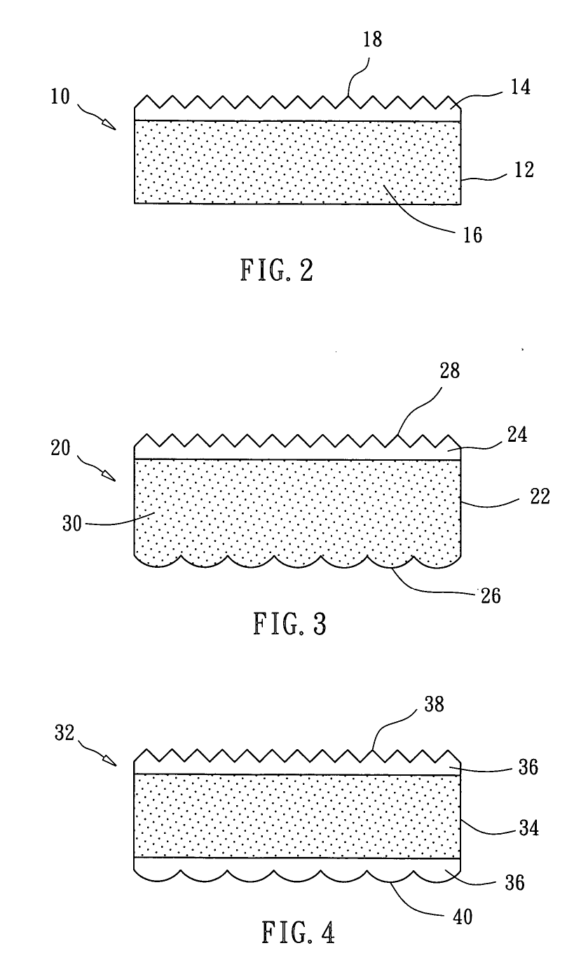

FIG. 2 shows an optical substrate 10 made by the method of the first preferred embodiment of the present invention, which has a first layer 12 and a second layer 14. The first layer 12 is made from the first material and the second layer 14 is made from the second material. The first layer 12 has diffusing particles 16 therein to serve the function of diffusion. The second layer 14 has a surface profile 18 to serve the function of the prism film and (or) the brightness enhancement film. The optical substrate have all of the functions that the conventional diffuser plate has but no glue is added in between the first layer 12 and the second layer 14 for lamination.

In the step (D), both of the roller calenders are provided with a specific figured texture respectively, so that both of the first material and the second material are rolled to mold a surface profile respectively, shown as an optical substrate 20 in FIG. 3. The optical substrate 20 has a first layer 22 and a second layer 24. On the first layer is a first surface profile 26 and on the second layer is a second surface profile 28. The first surface profile 26 is designated to serve the function of the diffusive film and the second surface profile 28 is designated to serve the function of the prism film and (or) the brightness enhancement film.

The optical substrate 20, as shown in FIG. 3, still has diffusing particles 30 in the first layer 22 for enhancement of the function of diffusion. For the reason of that the first surface profile 26 serves the function of diffusion, the first layer 22 might be provided with no diffusing particle therein. In the steps of fabrication, it only has to prepare the first material with no diffusing particle doped.

In the step (B), after the first material and the second material are provided to the adaptor, the adaptor divides the second material and the sends them to opposite sides of the first material respectively, in the other words, there are two second materials stacked on the opposite sides of the first material. FIG. 4 shows such an optical substrate 32, which has a first layer 34 and two second layers 36 on opposite sides of the first layer 34 respectively. The first layer 34 is made from the first material and the second layers 36 are made from the second material. The second layers 36 respectively have a surface profile 38 and 40 on exterior sides thereof. The second material, which makes the second layers, is a material with a lower water absorption, such as Cyclic Olefins Polymer (COP) or Cyclic Olefins Copolymer (COC).

In the method of the first preferred embodiment of the present invention, the substrate is rolled and is molded with the surface profile in a single step (the step (D)). In practice, the surface profile can be molded on the substrate after the cooling step by means of the conventional methods, such as the rolling process, the printing process, the photolithography process etc.

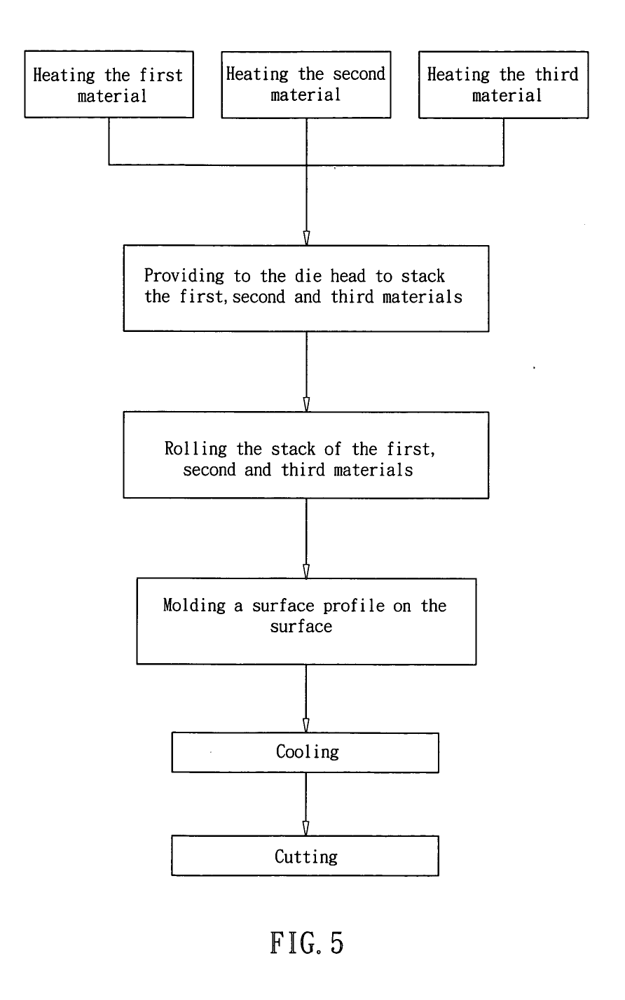

FIG. 5 is a flow chart showing a method of the second preferred embodiment of the present invention, which comprises the steps of:

(A) Heat a first material, a second material and a third material to their melt conditions.

(B) Provide the first material, the second material and the third material to a die head with multi-runner. The die head stacks the first material, the second material and the third material. The die head further extends a stack of the first material, the second material and the third material to a predetermined width.

(C) Roll a stack of the first material, the second material and the third material by means of a set of first roller calenders to mold a substrate with a predetermined thickness.

(G) Roll the substrate again by means of a set of second roller calenders. One of the roller calenders has a figured texture on an annular surface thereof to mold a predetermined surface profile on the second material while the substrate is rolled.

(D) Cool the substrate, and

(E) Cut the substrate.

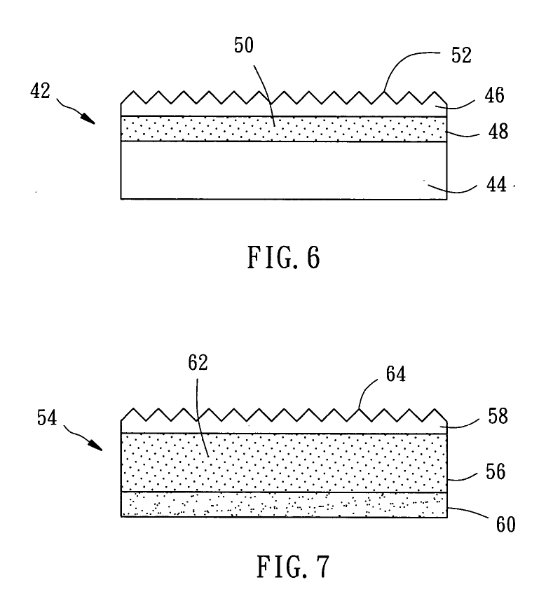

As shown in FIG. 6, an optical substrate 42 made from the steps of the method of the second preferred embodiment of the present invention has a first layer 44, a second layer 46 and a third layer 48, wherein the third layer 48 is arranged in between the first layer 44 and the second layer 46. The first layer 44 is made from the first material, the second layer 46 is made from the second material and the third layer 48 is made from the third material. The first layer 44 is a transparent plate, the third layer 48 has diffusing particles 50 therein for diffusion and the second layer 46 has a surface profile 52 for brightness enhancement. In the step (G), both of the second roller calenders can be provided with a figured texture respectively so that both of the first layer 44 and the second layer 46 are molded with a surface profile (only the surface profile 52 on the second layer 44 is shown) respectively.

In the second preferred embodiment, we provide the first material, the second material and the third material having individual optical characters. For example, the materials respectively have the optical characters of higher transparency, doped diffusing particles, lower water absorption or higher reflection etc. that makes each layer of the optical substrate having a superior performance in a designated optical function.

In step (B), the second material and the third material can be sent to opposite sides of the first material respectively in the die head to mold an optical substrate 54 as shown in FIG. 7. The optical substrate 54 has a first layer 56, a second layer 58 and a third layer 60, wherein the first layer 56 is arranged in between the second layer 58 and the third layer 60. The first layer 56 has diffusing particles 62 therein and the second layer 58 has a surface profile 64. The third material has a higher reflection character so that the third layer 60 serves as a reflector.

The third layer 60 can be molded with a surface profile (not shown) as described above. The structure of such optical substrate is similar to the optical substrate shown in FIG. 4, except that the layers on opposite sides of the first layer are made of different materials.

For the same principle, the method of the present invention can provide four (or more) materials to mold the optical substrate. The optical substrate might have four or more layers and the stack sequence of the layers of the optical substrate and the function of each layer are designated by the manufacturers.

1. A method of fabricating an optical substrate, comprising the steps of:
heating a first material and a second material to their melt conditions;
stacking the first material and the second material;
pressing a stack of the first material and the second material to mold a substrate with a predetermined width and a predetermined thickness;
molding a surface profile on the second material, and
cooling the substrate.

2. The method as defined in claim 1, wherein the second material is divided and is stacked on opposite sides of the first material respectively.

3. The method as defined in claim 2, wherein both of the second materials stacked on the opposite sides of the first material are molded with a surface profile respectively.

4. The method as defined in claim 1, wherein the first material has diffusing particles therein.

5. The method as defined in claim 1, further comprising the step of molding a surface profile on the first material.

6. The method as defined in claim 1, wherein step of pressing the stack of the first material and the second material and the step of molding the surface profile on the second material are done in a single step.

7. The method as defined in claim 1, further comprising the step of cutting the substrate after cooling.

8. The method as defined in claim 1, wherein a roller calender with a figured texture thereon is provided to roll the stack of the first material and the second material and to mold the surface profile.

9. A method of fabricating an optical substrate, comprising the steps of:
heating a first material, a second material and a third material to their melt conditions;
stacking the first material, the second material and the third material;
pressing a stack of the first material, the second material and the third material to mold a substrate with a predetermined width and a predetermined thickness;
molding a surface profile on the second material of the substrate, and cooling the substrate.

10. The method as defined in claim 9, wherein the third material is stacked on the first material and the second material is stacked on the third material.

11. The method as defined in claim 9, wherein the second material and the third material are stacked on opposite side of the first material.

12. The method as defined in claim 10, further comprising the step of molding a surface profile on the first material.

13. The method as defined in claim 11, further comprising the step of molding a surface profile on the third material.

14. The method as defined in claim 9, wherein the step of pressing the stack of the first material, the second material and the third material and molding the surfacing profile are done in a single step.

15. The method as defined in claim 9, wherein a roller calender with a figured texture is provided to roll the stack of the first material, the second material and the third material and to mold the surface profile

16. The method as defined in claim 9, further comprising the step of cutting the substrate after cooling.

17. A method of fabricating an optical substrate, comprising the steps of:
heating a first material and a second material to their melt conditions;
stacking the first material, the second material and the third material;
extending a stack of the first material and the second material to mold a substrate with a predetermined width;
pressing the substrate to a thickness, and
molding a surface profile on the substrate.
